(19) United States
(12) Patent Application Publication
(10) Pub. No.: US 2007/0091180 A1
(43) Pub. Date: Apr. 26, 2007

(54) Method and apparatus for using graphic object recognition in mobile communication terminal

(75) Inventor: Jae-Byeong Han, Anyang-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/545,239

(22) Filed: Oct. 10, 2006

(30) Foreign Application Priority Data
Oct. 8, 2005 (KR) 2005-94634

(51) Int. Cl. H04N 5/225

(52) U.S. Cl. 348/207.99

(57) ABSTRACT

Provided are a method and an apparatus of configuring and executing a menu using graphic object recognition in a mobile communication terminal. An object setting method using a specific object of a background picture as an execution indicator for executing a specific function with a touch pad includes receiving, at a controller of the mobile communication terminal, a graphic file or photograph file selected as a background picture by a user; displaying a specific object tracing along a boundary of the specific object within the selected background picture; and selecting the specific object by detecting a clicking of a completion button on the background picture, or an end button of a keypad.

### PRIORITY

This application claims priority under 35 U.S.C. §119 to a Korean application filed in the Korean Intellectual Property Office on Oct. 8, 2005 and allocated Serial No. 2005-94634, the contents of which are incorporated herein by reference.

### BACKGROUND OF THE INVENTION

1. Field of the Invention

The present invention relates generally to graphic object recognition technology in a mobile communication terminal and particularly a method and an apparatus for configuring and executing a menu using graphic object recognition in a mobile communication terminal.

2. Description of the Related Art

The use of mobile communication terminals is rapidly increasing due to portable convenience. With the increasing use of mobile communication terminals, service providers (and terminal manufacturers) are competitively developing mobile communication terminals having a variety of additional functions so as to attract many users. For example, mobile communication terminals provide a phone book function, a game function, a short messaging service (SMS) function, an Internet connection function, a morning call or wake-up function, a file viewer function, a file transfer function, an automatic answering function and a camera function.

Also, with the rapid distribution of mobile communication terminals having a liquid crystal display (LCD) and a camera function, photographs or color graphic pictures can be used as background pictures of the mobile communication terminals.

Such background pictures, however, are just used as a picture and cannot be used as interface information. That is, objects in the photographs or color graphic pictures are not used as a means for activating a function of the mobile communication terminal.

For example, when a family photograph is used as the background picture, the graphic objects of the family members on the background picture cannot be interfaced with functions of the mobile communication terminal.

### SUMMARY OF THE INVENTION

An object of the present invention is to substantially solve at least the above problems and/or disadvantages described above and to provide at least the advantages below. Accordingly, an object of the present invention is to provide a method and an apparatus of configuring and executing a menu using graphic object recognition in a mobile communication terminal. For example, when a family photograph is used as a background picture, the family members on the family photograph are interfaced with their information and a specific function is executed.

According to one aspect of the present invention, a method for setting an object of a background picture as an execution indicator for executing a function in a mobile communication terminal includes setting a graphic file or a photograph file as a background picture, selecting an object in the selected background picture, and setting an interface function of the mobile communication terminal corresponding to the selected object.

According to another aspect of the present invention, a method for executing an interface function corresponding to an object of a background picture as an execution indicator in a mobile communication terminal includes detecting whether an object of the background picture is sensed, and executing the interface function corresponding to the object when the object is sensed.

According to a further aspect of the present invention, a mobile communication terminal for setting an object of a background picture as an execution indicator includes a touch pad for displaying a graphic file or a photograph file and a controller for setting a graphic file or a photograph file as a background picture, selecting an object in the displayed background picture, and setting an interface function of the mobile communication terminal corresponding to the selected object.

According to a further aspect of the present invention, a mobile communication terminal for executing an interface function corresponding to an object of a background picture as an execution indicator includes a touch pad for displaying a graphic file or a photograph file including objects and a controller for detecting whether an object of the background picture is sensed and executing the interface function corresponding to the object when the object is sensed.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a mobile communication terminal according to the present invention;

FIG. 2 is a flowchart illustrating a method for setting a graphic object for a menu interface according to the present invention;

FIG. 3 is a flowchart illustrating a process for executing a specific function using graphic object recognition according to the present invention; and

FIGS. 4A, 4B and 4C are screenshots of photographs when the specific function is executed using the graphic object recognition according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a method and an apparatus of configuring a menu using graphic object recognition in a mobile communication terminal and a method of executing a specific function therein will be described in detail.

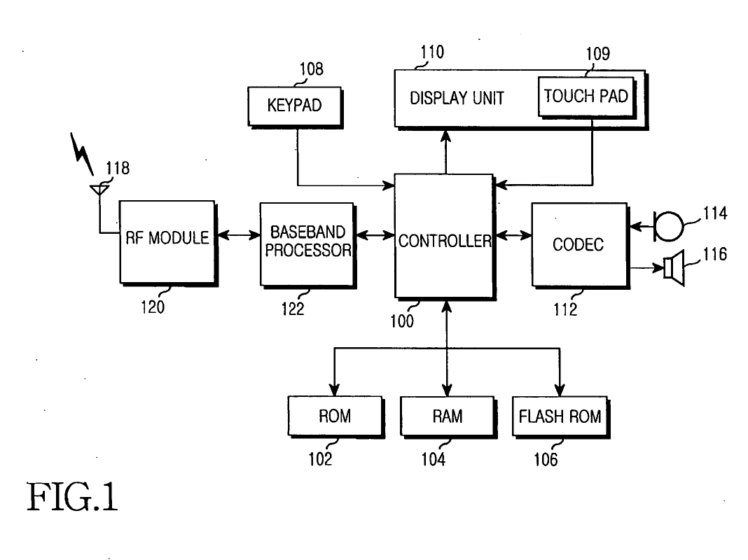

FIG. 1 is a block diagram of a mobile communication terminal according to the present invention. Some examples of the mobile communication terminal include a cellular phone, a Personal Communication Service (PCS) terminal, a Personal Data Assistant (PDA) terminal, an International Mobile Communication-2000 (IMT-2000) terminal, and a Wibro terminal. A following description will be made with reference to a general structure of the terminals.

Referring to FIG. 1, a controller (e.g., a microprocessor unit (MPU)) 100 controls an overall operation of the mobile communication terminal. For example, the controller 100 processes and controls voice communication and data communication. Also, the controller 100 processes and controls a menu configuration and an execution function using a graphic object setting according to the present invention. A detail description about typical process and control operations of the controller 100 will be omitted.

A read only memory (ROM) 102, a random access memory (RAM) 104 and a flash ROM 106 constitute a memory means.

Read only memory (ROM) 102 stores microcodes of a program for controlling the controller 100 and a variety of reference data. Specifically, the ROM 102 stores a program for the menu configuration and execution function using the graphic object setting according to the present invention.

Random access memory (RAM) 104 is a working memory of the controller 100 and temporarily stores data that are generated during the execution of various programs.

Flash ROM 106 stores a variety of updateable data, such as a phone book, a sent message, and a received message. Specifically, the flash ROM 106 stores menu configuration setup data, graphic data, or photograph data using the graphic object setting according to the present invention.

Keypad 108 includes numeric keys such as digits 0-9 and a plurality of function keys, such as a Menu key, a Cancel (Delete) key, a Confirmation key, a Talk key, an End key, an Internet connection key, and Navigation keys (or direction keys). When a specific key of the keypad 108 is pressed, a corresponding key input data is provided to the controller 100.

Display unit 110 displays status information generated during the operation of the mobile communication terminal, numerals, characters, moving pictures, still pictures, and so on. A color liquid crystal display (LCD) may be used for the display unit 110. Also, the display unit 110 may include a touch pad 109.

The touch pad 109 is disposed on a front surface of the display unit 110 and provides the controller 100 with touch data generated by the user's touch thereon. For example, when the user touches the touch pad 109, touch data according to the touch region is provided to the controller 100 and then the controller 100 calculates the coordinate value of the touch region based on the touch data.

A codec 112 connected to the controller 100, and a microphone 114 and a speaker 116 connected to the codec 112, serve as an audio input/output block for telephone call and voice recording.

The codec 112 converts Pulse-Code Modulation (PCM) data provided from the controller 100 into analog audio signals. The analog audio signals are output through the speaker 116. Also, the codec 112 converts audio signals received through the microphone 114 into PCM data and provides the converted PCM data to the controller 100.

Radio frequency (RF) module 120 down-converts RF signals received through an antenna 118 and provides the down-converted RF signals to a baseband processor 122. Also, the RF module 120 up-converts baseband signals from the baseband processor 122 and transmits the up-converted baseband signals through the antenna 118.

The baseband processor 122 processes the baseband signals transmitted/received between the RF unit 120 and the controller 100. For example, in the case of data transmission, the baseband processor 122 performs channel coding and spreading on transmit (TX) data, and in the case of data reception, the baseband processor 122 performs despreading and channel decoding on receive (RX) data.

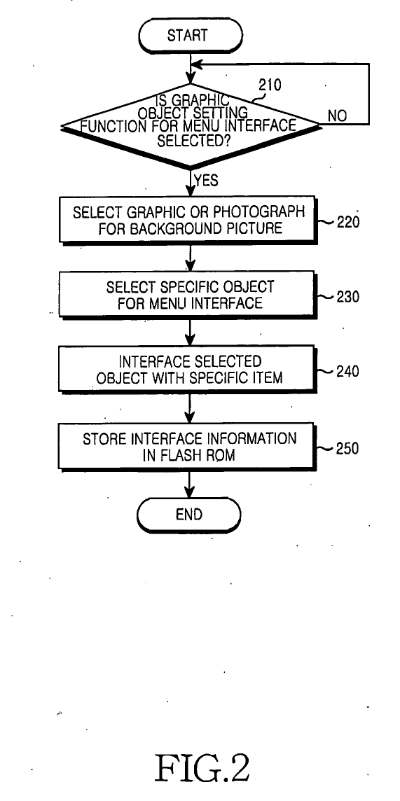

FIG. 2 is a flowchart illustrating a method of setting a graphic object for a menu interface according to the present invention.

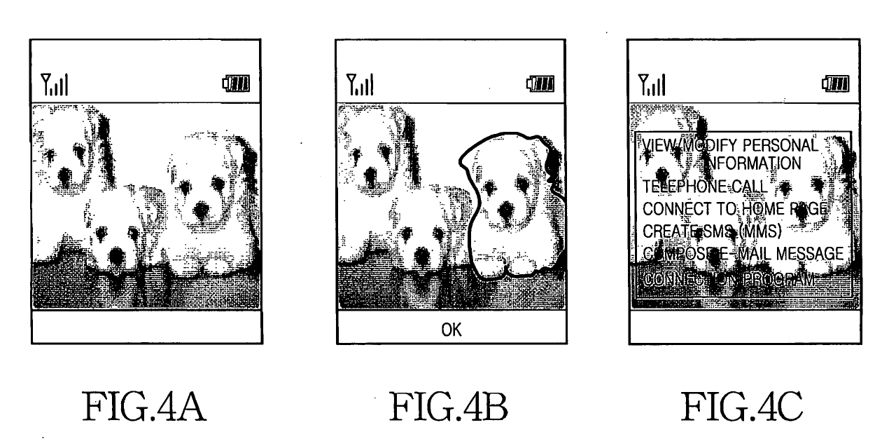

Referring to FIG. 2, in steps 210 and 220, when the controller 100 detects a user's selection of a graphic object setting function for a menu interface, it receives a computer graphic picture or photograph, which will be used as a background picture, from the user. An exemplary photograph selected by the user and displayed on the display unit 110 is illustrated in FIG. 4A.

In step 230, the controller 100 receives a specific object for a menu interface in the background picture.

Since the touch pad 109 is disposed on the front side of the display unit 110, it generates touch data to the controller 110 when the user touches a specific region of the background picture displayed on the display unit 110.

The user's selection of the specific object will be processed as follows. Using an input device (e.g., a stylus) for the touch pad 109, or the user's finger, the user selects the specific object by tracing along a boundary of the specific object of the background picture as illustrated in FIG. 4B. Then, the user clicks a completion button (or an OK button) displayed on the background picture or an END button of the keypad 108. Through these procedures, the selecting operation is finished.

In step 240, the controller 100 receives the selected specific object and a specific item to be interfaced among the user menu of the mobile communication terminal. In step 250, the interface information is stored in the flash ROM 106. Then, the process of the present invention is terminated.

If the selected specific item is a person, the specific item may include personal information such as address and telephone number. Also, the selected specific item may include additional functions such as a calculator function and world clock function. That is, the interface of the specific item may be changed according to the user's selection.

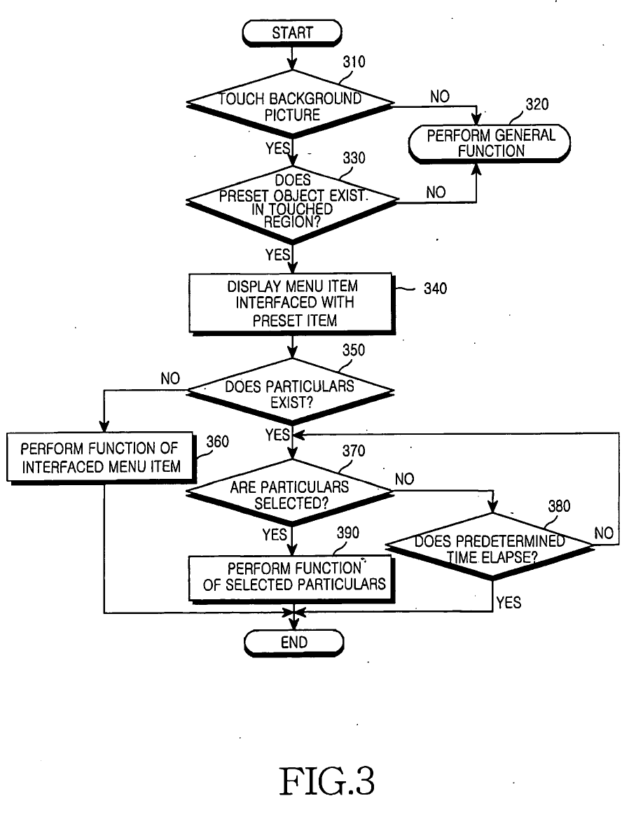

FIG. 3 is a flowchart illustrating a process of executing a specific function using graphic object recognition according to the present invention.

Referring to FIG. 3, in step 310, the controller 100 checks whether the user touches the background picture. In step 320, when the background picture is not touched, the controller 100 performs a general function.

In step 330, when the background is touched, the controller 100 checks whether the touched region is a region where the preset object exists.

In case where the user touches the touch pad 109, the touch data is transferred to the controller 100, and the controller 100 calculates a coordinate value based on the received touch data and searches the touched region. Then, the controller 100 inspects whether the touched region is the region in which the preset specific object exists.

When the touched region is not the region in which the preset specific exists, the controller 100 performs a general function in step 320.

In step 340, when the touched region is the region in which the preset specific exists, the controller 100 displays a specific item of the menu, which is interfaced with the specific object, on the display unit 110.

In step 350, the controller 100 checks particulars of the interfaced specific item. Here, particulars mean that there are sub items.

In step 360, when there are no particulars, the controller 100 performs the function of the interfaced menu item. That is, in case where the specific object is interfaced with an additional function such as a calculator function and a world clock function, the controller 100 performs the calculator function or the world clock function when the user selects the specific object.

In step 370, the controller 100 checks if particulars of the specific item displayed in operation 340 are selected.

For example, if the selected specific object is a puppy and the specific item interfaced with the puppy is a function associated with personal information such as address or telephone number of the puppy's owner, the result can be displayed as illustrated FIG. 4C.

In step 380, if the user does not select the item, the controller 100 checks whether a predetermined time has elapsed. If the predetermined time has not elapsed, the process returns to step 370.

In step 390, when the user selects the item, the controller 100 performs a function of the selected item. Then, the process is terminated.

For example, when a “telephone call” item is selected in FIG. 4C, the mobile communication terminal attempts a telephone call to the telephone number of the person associated with the selected specific object.

As described above, the specific object is set from the graphic picture or the photograph displayed as the background picture, and the specific object is associated with an item or function of the specific menu, thus making it possible to use the mobile communication terminal intuitively.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for setting an object of a background picture as an execution indicator for executing a function in a mobile communication terminal, comprising:
setting one of a graphic file and a photograph file as a background picture;
selecting an object in the selected background picture; and
setting an interface function of the mobile communication terminal corresponding to the selected object.

2. The method of claim 1, further comprising storing information of the interface function corresponding to the selected object in a memory means.

3. The method of claim 2, wherein the information includes a file name of the background picture, a coordinate value of the selected object of the background picture and a name of the interface function corresponding to the object.

4. The method of claim 1, wherein the interface function is one of functions originally set in the mobile communication terminal.

5. A method for executing an interface function corresponding to an object of a background picture as an execution indicator in a mobile communication terminal, comprising:
detecting whether an object of the background picture is sensed; and
executing an interface function corresponding to the object when the object is sensed.

6. The method of claim 5, further comprising, after the step of detecting:
displaying a list of interface functions when the object is sensed; and
selecting one interface function among the list of interface functions.

7. A method of inspecting whether a preset object exists in a region touched by a user in a background picture of a mobile communication terminal, comprising:
extracting a coordinate value of the touched region; and
checking whether the preset object is in a position that matches with the extracted coordinate value.

8. A mobile communication terminal for setting an object of a background picture as an execution indicator, comprising:
a touch pad for displaying one of a graphic file and a photograph file; and
a controller for setting one of the graphic file and the photograph file as a background picture, selecting an object in the displayed background picture, and setting an interface function of the mobile communication terminal corresponding to the selected object.

9. The mobile communication terminal of claim 8, wherein the controller stores information of the interface function corresponding to the selected object in a memory means.

10. The mobile communication terminal of claim 9, wherein the information includes a file name of the background picture, a coordinate value of the selected object of the background picture and a name of the interface function corresponding to the object.

11. The mobile communication terminal of claim 8, wherein the interface function is one of a plurality of functions originally set in the mobile communication terminal.

12. A mobile communication terminal for executing an interface function corresponding to an object of a background picture as an execution indicator, comprising:
a touch pad for displaying one of a graphic file and a photograph file including objects; and
a controller for detecting whether an object of the background picture is sensed and executing the interface function corresponding to the object when the object is sensed.

13. The mobile communication terminal of claim 12, wherein the controller, after detecting whether the object is sensed, displays a list of interface functions when the object is sensed and selects one interface function among the list of interface functions.

14. A mobile communication terminal for determining whether a preset object exists in a region touched by a user in a background picture, comprising:
a touch pad for displaying one of a graphic file and a photograph file including objects; and
a controller for extracting a coordinate value of the touched region of the touch pad and checking whether the preset object is in a position that matches with the extracted coordinate value.
